(19) United States
(12) Patent Application Publication
(10) Pub. No.: US 2014/0211773 A1
(43) Pub. Date: Jul. 31, 2014

(54) VEHICLE WIRELESS ROUTER

(71) Applicant: Nai-Chien CHANG, New Taipei City (TW)

(72) Inventor: Nai-Chien CHANG, New Taipei City (TW)

(21) Appl. No.: 14/155,840

(22) Filed: Jan. 15, 2014

(30) Foreign Application Priority Data
Jan. 31, 2013 (TW) 102202173

(51) Int. Cl. H04W 88/08

(52) U.S. Cl. CPC H04W 88/08
USPC 370/338

(57) ABSTRACT

A vehicle wireless router includes a printed circuit board, a cigarette lighter port, a central processing unit, a network module and an antenna unit. The printed circuit board is electrically connected to the cigarette lighter port, the central processing unit, the network module and the antenna unit. The cigarette lighter port is plugged into a vehicle charger socket of a vehicle. The vehicle wireless router receives power from the vehicle through the vehicle charger socket and the cigarette lighter port. The central processing unit receives power through the cigarette lighter port. The central processing unit is configured to start the network module after the central processing unit is power-on. Therefore, a wireless network is shared by the vehicle wireless router through the network module and the antenna unit. An electronic device in the vehicle can be connected to the Internet through the vehicle wireless router.

### BACKGROUND OF THE INVENTION

1. Field of the Invention

The present invention relates to a wireless router, and especially relates to a vehicle wireless router.

2. Description of the Related Art

In recent years, various smart electronic devices, for examples, smart phones or tablet PCs, are popular because the Internet is available easily. The smart electronic devices are portable. People can use the smart electronic devices to connect to the Internet. It is very convenient.

Generally speaking, the smart electronic devices can be connected to the Internet through the telecommunication networks (for examples, 3G, 3.5G or 4G/LTE) or Wi-Fi access points. The smart electronic devices can be connected to the Internet through the Wi-Fi access points if the smart electronic device has Wi-Fi connection function. The smart electronic device can be connected to the Internet if there are telephone signals and the smart electronic device has telecommunication network connection function. It is very convenient.

Generally speaking, a SIM card is necessary for connecting to the Internet through the telecommunication networks. The SIM card arranged into the smart electronic device processes the 3G, 3.5G or 4G/LTE network signals. However, the telecommunication company will charge the user who uses the SIM card, and one piece of SIM card is usable for one electronic device only. A lot of SIM cards are necessary if the user has many smart electronic devices. It is not economical.

Therefore, most users will use the smart electronic devices having Wi-Fi connection function. However, the Wi-Fi access points are not available easily, especially in the outdoors. The smart electronic device cannot be connected to the Internet if the smart electronic device only has Wi-Fi connection function.

Moreover, the Wi-Fi access points are fixed. The Wi-Fi access point which is connected to the smart electronic device will be changed if the user holding the smart electronic device is moving (for example, in a moving car) even if the Wi-Fi access points are available in the outdoors. It is inconvenient.

### SUMMARY OF THE INVENTION

In order to solve the above-mentioned problems, an object of the present invention is to provide a vehicle wireless router. The vehicle wireless router receives power from a vehicle through a vehicle charger socket of the vehicle. Therefore, the smart electronic device in the vehicle can be connected to the Internet.

In order to achieve the object of the present invention mentioned above, the vehicle wireless router includes a printed circuit board, a cigarette lighter port, a central processing unit, a network module and an antenna unit. The printed circuit board is electrically connected to the cigarette lighter port, the central processing unit, the network module and the antenna unit. The cigarette lighter port is plugged into a vehicle charger socket of a vehicle. The vehicle wireless router receives power from the vehicle through the vehicle charger socket and the cigarette lighter port. The central processing unit receives power through the cigarette lighter port. The central processing unit is configured to start the network module after the central processing unit is power-on. Therefore, a wireless network is shared by the vehicle wireless router through the network module and the antenna unit. A smart electronic device in the vehicle can be connected to the Internet through the vehicle wireless router.

The efficiency of the present invention is that the vehicle wireless router receives power from the vehicle through the vehicle charger socket of the vehicle and the cigarette lighter port. Therefore, the smart electronic device in the vehicle can be connected to the Internet through the wireless network signals provided by the vehicle wireless router.

### BRIEF DESCRIPTION OF DRAWING

FIG. 1 shows an exploded view of the first embodiment of the vehicle wireless router of the present invention.

FIG. 2 shows a perspective view of the first embodiment of the vehicle wireless router of the present invention.

FIG. 3 shows a block diagram of the first embodiment of the vehicle wireless router of the present invention.

FIG. 4 shows an exploded view of the second embodiment of the vehicle wireless router of the present invention.

FIG. 5 shows a schematic diagram of the first embodiment showing how the vehicle wireless router is used.

FIG. 6 shows a perspective view of the third embodiment of the vehicle wireless router of the present invention.

FIG. 7 shows a block diagram of the third embodiment of the vehicle wireless router of the present invention.

FIG. 8 shows a perspective view of the fourth embodiment of the vehicle wireless router of the present invention.

FIG. 9 shows a block diagram of the fourth embodiment of the vehicle wireless router of the present invention.

### DETAILED DESCRIPTION OF THE INVENTION

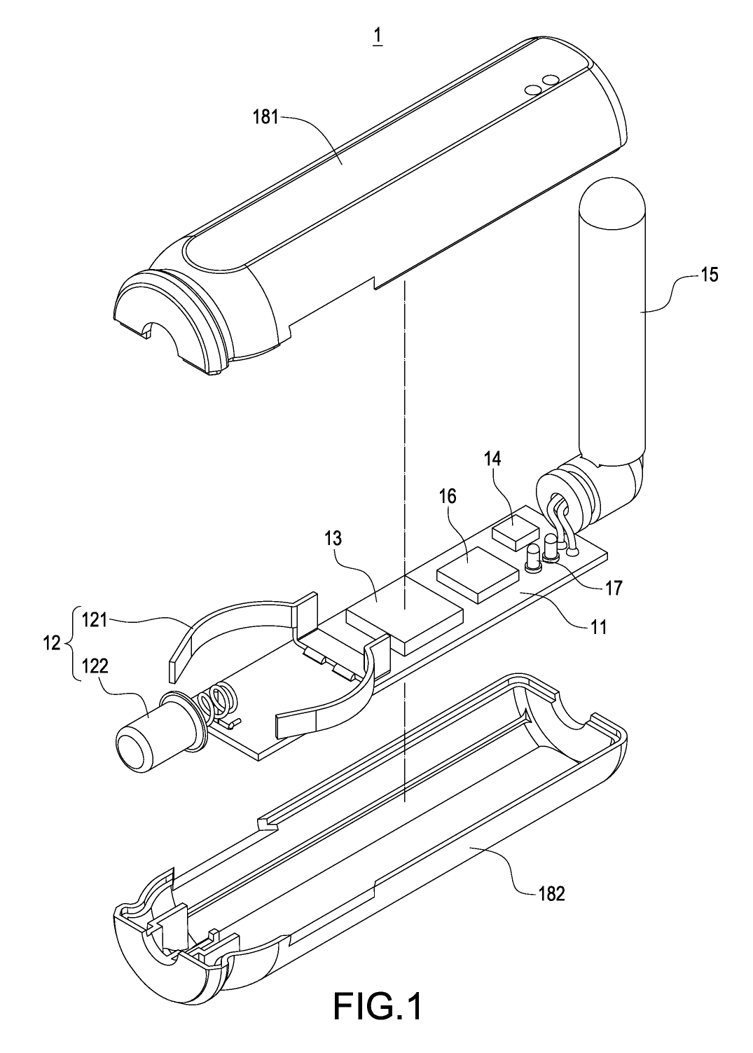

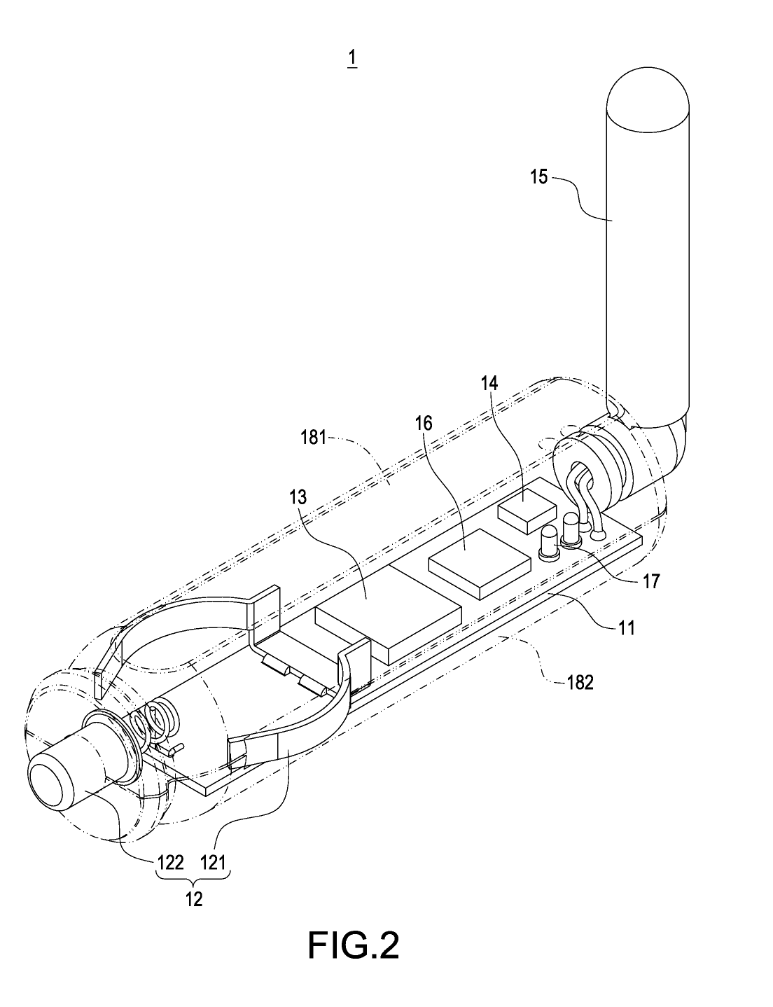

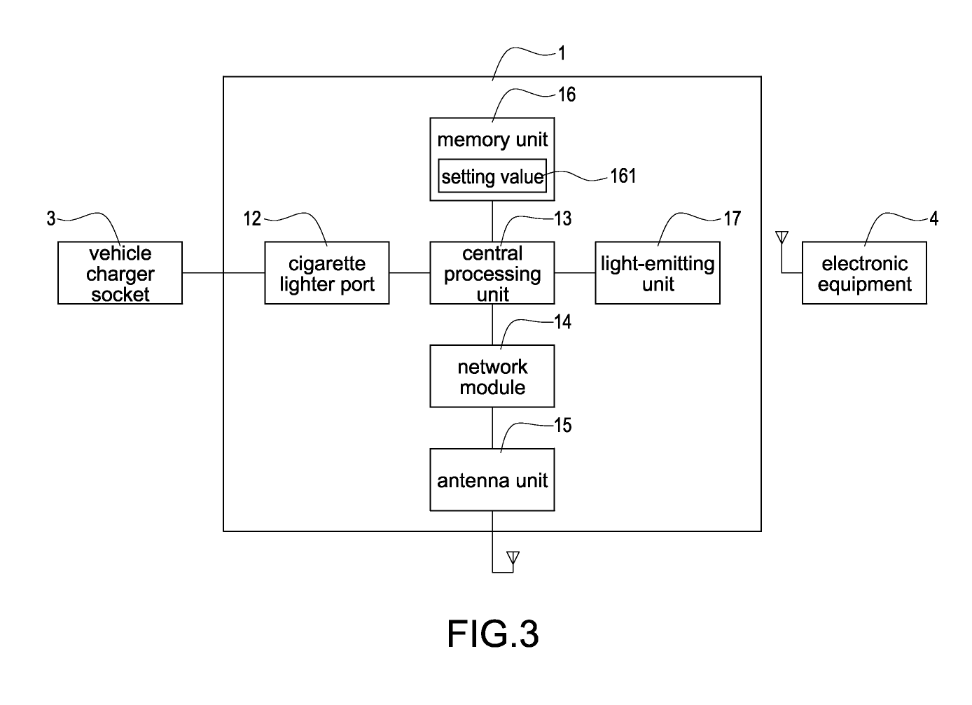

FIG. 1 shows an exploded view of the first embodiment of the vehicle wireless router of the present invention. FIG. 2 shows a perspective view of the first embodiment of the vehicle wireless router of the present invention. FIG. 3 shows a block diagram of the first embodiment of the vehicle wireless router of the present invention. A vehicle wireless router 1 includes a printed circuit board 11, a cigarette lighter port 12, a central processing unit 13, a network module 14, an antenna unit 15 and a memory unit 16.

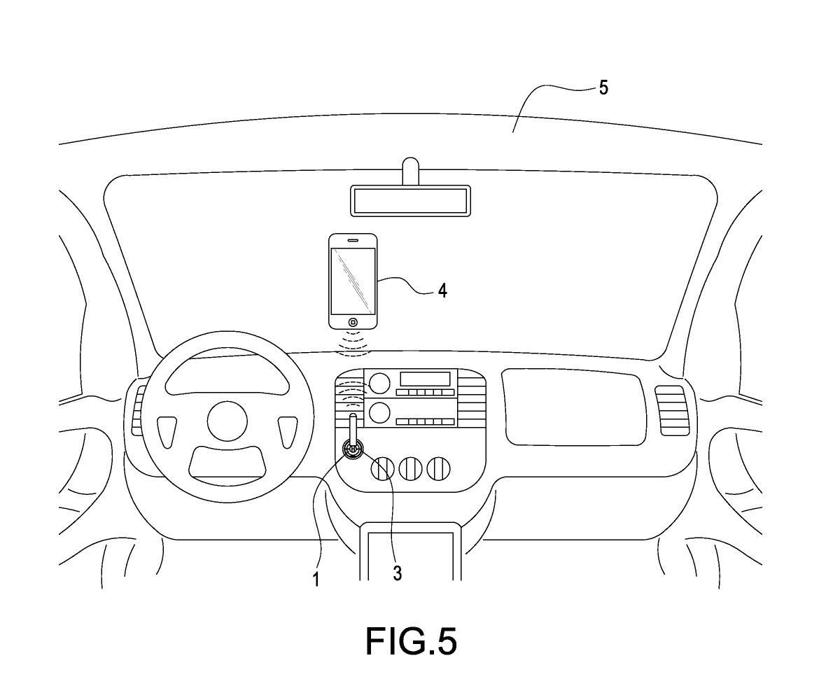

The cigarette lighter port 12 is electrically connected to the printed circuit board 11 and the central processing unit 13 (through the printed circuit board 11). The vehicle wireless router 1 is connected to a vehicle charger socket 3 of a vehicle 5 (shown in FIG. 5) through the cigarette lighter port 12. The vehicle wireless router 1 receives power from the vehicle 5 through the vehicle charger socket 3. Therefore, the wireless network signals are shared by the vehicle wireless router 1 in the vehicle 5.

The cigarette lighter port 12 includes a cathode elastic piece 121 and an anode contact 122. The cathode elastic piece 121 and the anode contact 122 are electrically connected to the printed circuit board 11 respectively. The vehicle wireless router 1 receives power from the vehicle 5 through the cathode elastic piece 121 and the anode contact 122 which are electrically connected to a power cathode and a power anode of the vehicle charger socket 3 (not shown in FIG. 1, FIG. 2 or FIG. 3) respectively when the vehicle wireless router 1 is plugged into the vehicle charger socket 3.

The central processing unit 13 is electrically connected to the printed circuit board 11 and the cigarette lighter port 12. The central processing unit 13 receives power through the cigarette lighter port 12. The central processing unit 13 is configured to process various signals in the vehicle wireless router 1. The network module 14 is electrically connected to the printed circuit board 11 and the central processing unit 13 (through the printed circuit board 11).

The central processing unit 13 is configured to start the network module 14 when the central processing unit 13 is power-on. According to circuits and chips in the network module 14, the network module 14 is connected to the telecommunication network and is configured to process 3G, 3.5G or 4G/LTE network signals. Therefore, the vehicle wireless router is connected to the Internet through the network module 14.

The antenna unit 15 is electrically connected to the printed circuit board 11 and the network module 14 (through the printed circuit board 11). The network module 14 is connected to the telecommunication network through the network protocols of the 3G, 3.5G or 4G/LTE. The network module 14 is configured to transfer the 3G, 3.5G or 4G/LTE network signals into Wi-Fi network signals.

The antenna unit 15 is connected to the network module 14. The antenna unit 15 transmits the 3G, 3.5G, 4G/LTE network signals and Wi-Fi network signals. Therefore, an electronic equipment 4 used by a user can be wirelessly connected to the vehicle wireless router 1 through the Wi-Fi network protocol to use the network signals shared by the vehicle wireless router 1.

The memory unit 16 is electrically connected to the printed circuit board 11 and the central processing unit 13 (through the printed circuit board 11). The memory unit 16 stores at least a setting value 161. The setting value 161 records parameters of the network module 14, for examples but not limited to, the connection name and password of the wireless network.

The vehicle wireless router 1 further includes a light-emitting unit 17 electrically connected to the printed circuit board 11. The light-emitting unit 17 is, for example but not limited to, a light-emitting diode. The light-emitting unit 17 is electrically connected to the central processing unit 13 through the printed circuit board 11. The central processing unit 13 is configured to control the light-emitting unit 17 lighting when the vehicle wireless router 1 is power-on.

Therefore, the user can know that the vehicle wireless router 1 is power-on when the light-emitting unit 17 is lighting. Moreover, the light-emitting unit 17 can be replaced by a LCD to display text or graphics for more information. Therefore, the user can know the operation details of the vehicle wireless router 1.

The vehicle wireless router 1 further includes an upper cover 181 and a lower cover 182 which cover the printed circuit board 11, the cigarette lighter port 12, the central processing unit 13, the network module 14, and the memory unit 16. The upper cover 181 and the lower cover 182 are used as a casing of the vehicle wireless router 1. The cathode elastic piece 121 and the anode contact 122 are arranged outside the upper cover 181 and the lower cover 182, so that the vehicle wireless router 1 is electrically connected to the vehicle charger socket 3 when the wireless router 1 is plugged into the vehicle charger socket 3. The light-emitting unit 17 is outside the upper cover 181 and the lower cover 182 as well, so that the user can see the light emitted from the light-emitting unit 17.

The antenna unit 15 is a telescopic antenna which is arranged outside the upper cover 181 and the lower cover 182. The antenna unit 15 is electrically connected to the network module 14 through a circuit (not shown in FIG. 1, FIG. 2 or FIG. 3). The direction and the length of the antenna unit 15 are adjustable for receiving better wireless signals.

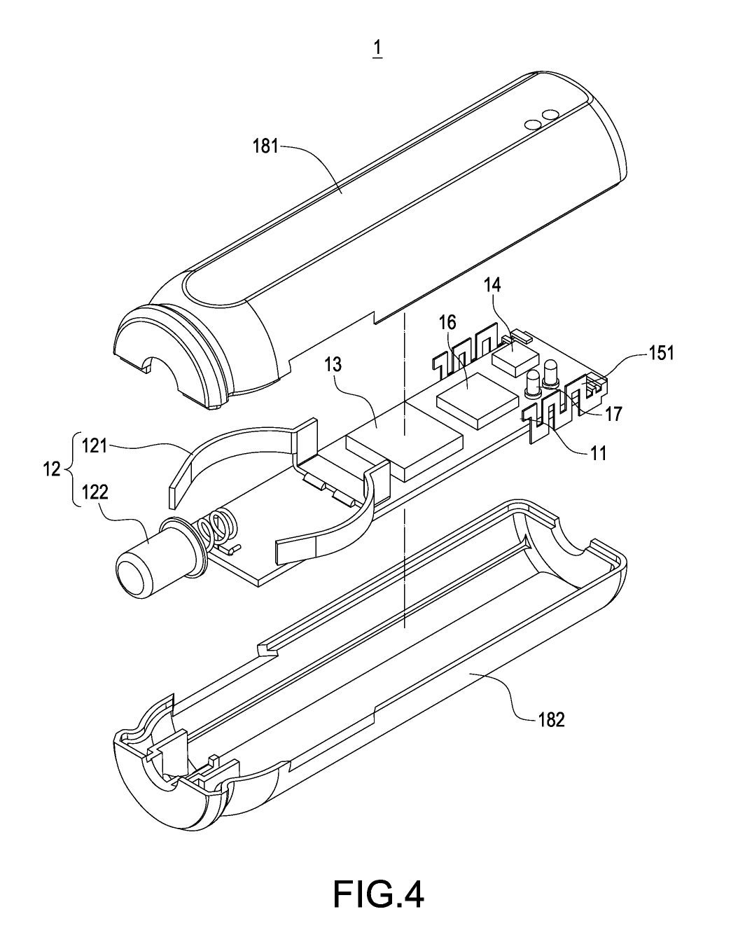

FIG. 4 shows an exploded view of the second embodiment of the vehicle wireless router of the present invention. The antenna unit 15 is a planar inverted F antenna (PIFA) arranged around the printed circuit board 11. The antenna unit 15 is electrically connected to the network module 14 directly. The PIFA is covered by the upper cover 181 and the lower cover 182. In another word, the PIFA is arranged inside the casing of the vehicle wireless router 1, so that the volume of the vehicle wireless router 1 is reduced.

FIG. 5 shows a schematic diagram of the first embodiment showing how the vehicle wireless router is used. The electronic equipment 4 which has Wi-Fi function but has no telecommunication network (3G or 4G) connection function cannot be connected to the Internet if there is no access point. In this embodiment, the network module 14 of the vehicle wireless router 1 is wirelessly connected to the telecommunication network through 3G, 3.5G or 4G/LTE if the vehicle wireless router 1 is plugged into the vehicle charger socket 3 of the vehicle 5 and is power-on. The network module 14 is configured to transfer the 3G, 3.5G or 4G/LTE network signals to the Wi-Fi network signals for sharing outside. Therefore, the electronic equipment 4 is wirelessly connected to the vehicle wireless router 1 through Wi-Fi, and then the electronic equipment 4 is connected to the Internet through the vehicle wireless router 1. It is very convenient.

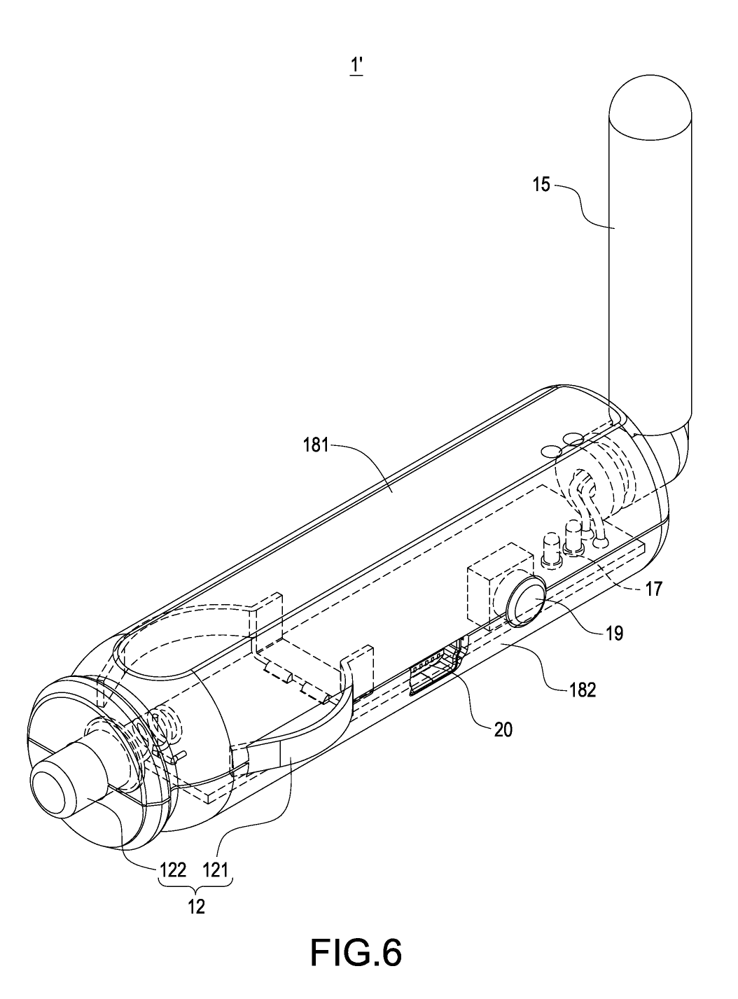

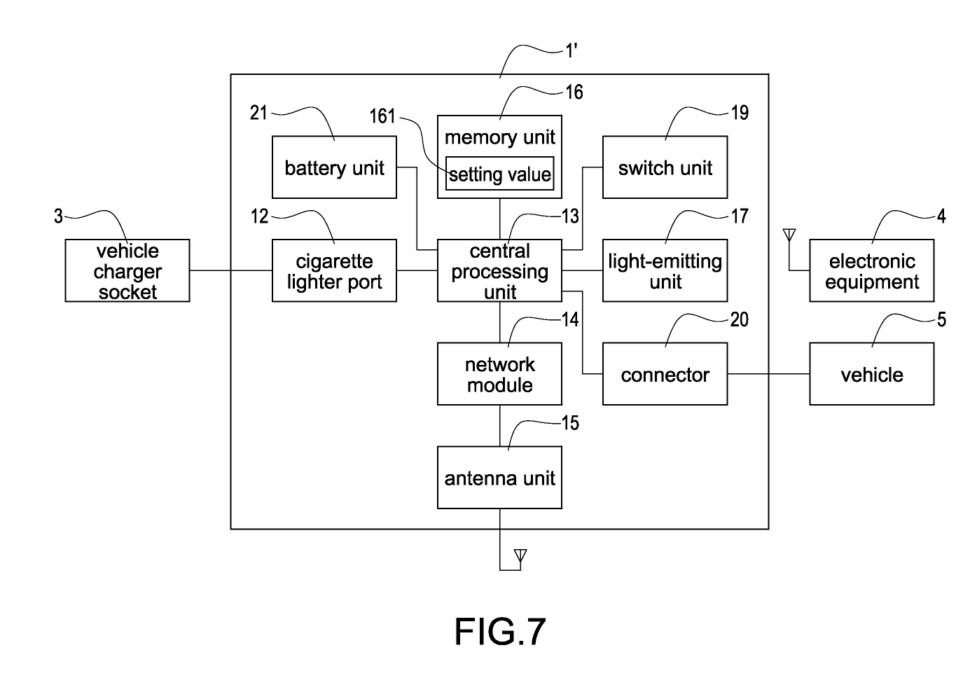

FIG. 6 shows a perspective view of the third embodiment of the vehicle wireless router of the present invention. FIG. 7 shows a block diagram of the third embodiment of the vehicle wireless router of the present invention. In this embodiment, a vehicle wireless router 1′ is provided. The vehicle wireless router 1′ further includes a switch unit 19, a connector 20 and a battery unit 21. The switch unit 19 is electrically connected to the printed circuit board 11 and the central processing unit 13 (through the printed circuit board 11). The startup and shutdown of the vehicle wireless router 1′ is controlled by switching the switch unit 19 after the vehicle wireless router 1′ receives power through the vehicle charger socket 3. Therefore, the user can turn off the vehicle wireless router 1′ by switching the switch unit 19, and the vehicle wireless router 1′ does not need to be removed from the vehicle charger socket 3.

The connector 20 is electrically connected to the printed circuit board 11 and the central processing unit 13 (through the printed circuit board 11). The connector 20 is electrically connected to the electronic equipment 4 through a transmission line (not shown in FIG. 1, FIG. 2 or FIG. 3). Therefore, the electronic equipment 4 can receive power from the vehicle 5 through the transmission line and the vehicle wireless router 1′. Moreover, even if the electronic equipment 4 does not have Wi-Fi connection function, the electronic equipment 4 can be connected to the Internet through the transmission line and the vehicle wireless router 1′, wherein the electronic equipment 4 has the ability of processing network signals. In this embodiment, the connector 20 is, for example but not limited to, a universal serial bus (USB).

The battery unit 21 is electrically connected to the printed circuit board 11 and the central processing unit 13 (through the printed circuit board 11). The battery unit 21 stores power received through the cigarette lighter port 12 when the vehicle wireless router 1′ is plugged into the vehicle charger socket 3. Therefore, the battery unit 21 provides power for the vehicle wireless router 1′ when the vehicle wireless router 1′ is removed from the vehicle charger socket 3.

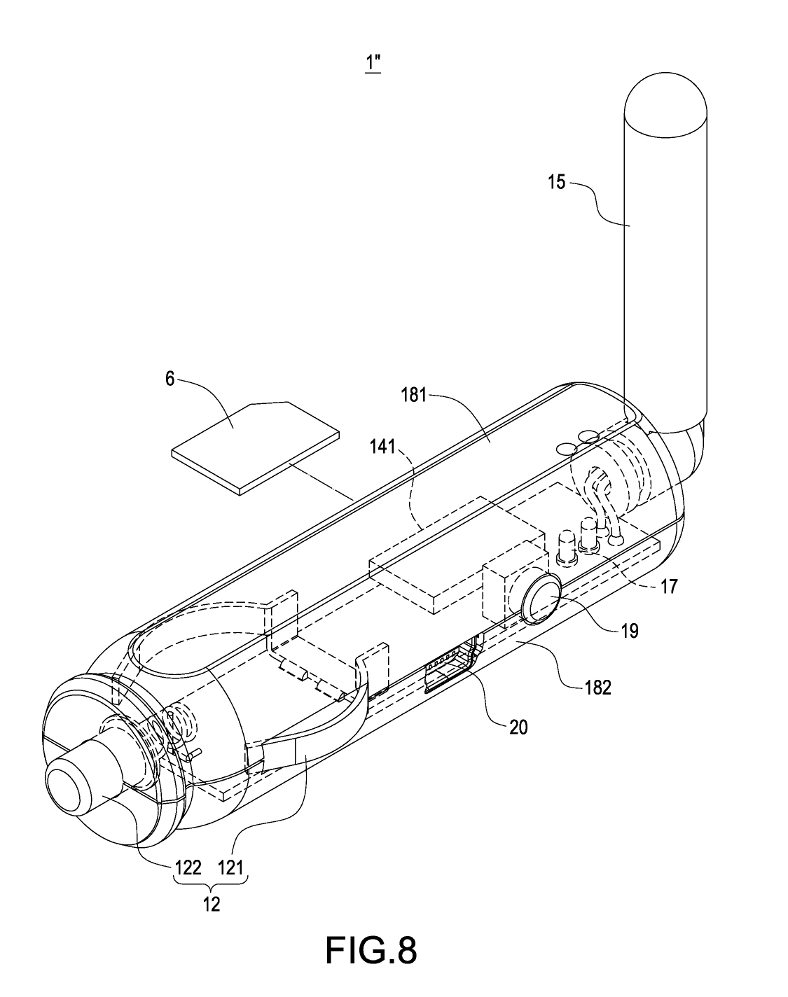

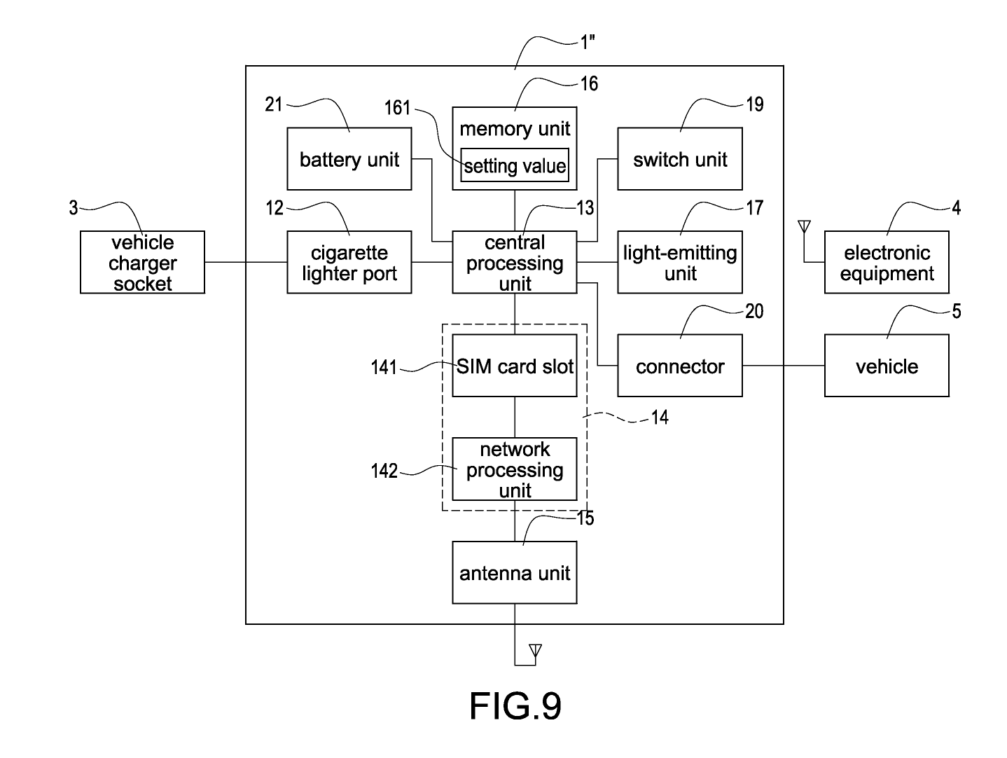

FIG. 8 shows a perspective view of the fourth embodiment of the vehicle wireless router of the present invention. FIG. 9 shows a block diagram of the fourth embodiment of the vehicle wireless router of the present invention. The network module 14 of the vehicle wireless router 1 and the vehicle wireless router 1′ mentioned above includes signal processing circuits or chips for processing the telecommunication network signals or the Wi-Fi network signals. The signal processing circuits or chips are integrated as an integrated circuit (IC). In this embodiment, a vehicle wireless router 1″ is provided. The network module 14 of the vehicle wireless router 1″ includes, for example but not limited to, a subscriber identity module (SIM) card slot 141 and a network processing unit 142, which are physically separated to each other.

The SIM card slot 141 is electrically connected to the printed circuit board 11 and the central processing unit 13 (through the printed circuit board 11). A SIM card 6 is plugged into the SIM card slot 141. The SIM card 6 is provided by the telecommunication service provider and has 3G, 3.5G or 4G/LTE network connection function. The network processing unit 142 is an IC electrically connected to the printed circuit board 11. The network processing unit 142 is electrically connected to the SIM card slot 141 and the antenna unit 15 through the printed circuit board 11. The network processing unit 142 is configured to process the 3G, 3.5G or 4G/LTE network signals provided by the SIM card 6 to communicate with the telecommunication service provider when the SIM card 6 is plugged into the SIM card slot 141. Moreover, the network processing unit 142 is configured to transfer the 3G, 3.5G or 4G/LTE network signals to the Wi-Fi signals. Then, the Wi-Fi signals are shared through the antenna unit 15. Therefore, as long as the SIM card 6 is plugged into the SIM card slot 141 and the vehicle wireless router 1″ is power-on, the electronic equipment 4 which has Wi-Fi connection function is connected to the vehicle wireless router 1″. The electronic equipment 4 is connected to the Internet by the telecommunication network connection function of the SIM card 6.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A vehicle wireless router electrically connected to a vehicle charger socket of a vehicle, the vehicle wireless router comprising:
a printed circuit board;
a cigarette lighter port electrically connected to the printed circuit board, the cigarette lighter port receiving power provided by the vehicle through the vehicle charger socket;
a central processing unit electrically connected to the printed circuit board and the cigarette lighter port, the central processing unit receiving power through the cigarette lighter port;
a network module electrically connected to the printed circuit board and the central processing unit, the central processing unit configured to start the network module, the network module connected to telecommunication networks through 3G, 3.5G and 4G/long term evolution (LTE) network signals, the network module configured to transfer the 3G, 3.5G and 4G/LTE network signals to Wi-Fi network signals;
an antenna unit electrically connected to the printed circuit board and the network module, the antenna unit sending out the Wi-Fi network signals provided by the network module; and
a memory unit electrically connected to the printed circuit board and the central processing unit, the memory unit storing a setting value recording parameters of the network module.

2. The vehicle wireless router in claim 1, further comprising an upper cover and a lower cover, the upper cover and the lower cover covering the printed circuit board, the cigarette lighter port, the central processing unit, the network module, and the memory unit.

3. The vehicle wireless router in claim 2, wherein the cigarette lighter port comprises a cathode elastic piece and an anode contact; the cathode elastic piece and the anode contact are electrically connected to the printed circuit board respectively; the cathode elastic piece and the anode contact are arranged outside the upper cover and the lower cover.

4. The vehicle wireless router in claim 3, further comprising a light-emitting unit electrically connected to the printed circuit board and the central processing unit, the light-emitting unit arranged outside the upper cover and the lower cover, the central processing unit configured to control the light-emitting unit lighting when the vehicle wireless router is power-on.

5. The vehicle wireless router in claim 3, further comprising a switch unit electrically connected to the printed circuit board and the central processing unit, the switch unit controlling the vehicle wireless router to be power-on or power-off when the vehicle wireless router receives power through the vehicle charger socket.

6. The vehicle wireless router in claim 3, further comprising a battery unit electrically connected to the printed circuit board and the central processing unit, the battery unit storing power received through the cigarette lighter port, the battery unit providing power for the vehicle wireless router when the cigarette lighter port is removed from the vehicle charger socket.

7. The vehicle wireless router in claim 3, further comprising a connector electrically connected to the printed circuit board and the central processing unit, the connector connected to a transmission line for outputting power received by the cigarette lighter port.

8. The vehicle wireless router in claim 3, wherein the network module comprises a subscriber identity module card slot and a network processing unit; the subscriber identity module card slot is electrically connected to the printed circuit board and the central processing unit; a subscriber identity module card is plugged into the subscriber identity module card slot; the subscriber identity module card has 3G, 3.5G or 4G/LTE network connection function; the network processing unit is electrically connected to the printed circuit board, the subscriber identity module card slot and the antenna unit; the network processing unit is configured to transfer the 3G, 3.5G or 4G/LTE network signals provided by the subscriber identity module card to the Wi-Fi network signals for sharing.

9. The vehicle wireless router in claim 8, wherein the antenna unit is a telescopic antenna which is arranged outside the upper cover and the lower cover; the antenna unit is electrically connected to the network module through a line.

10. The vehicle wireless router in claim 8, wherein the antenna unit is a planar inverted f antenna arranged around the printed circuit board; the antenna unit is covered by the upper cover and the lower cover.
